(19) United States
(12) Patent Application Publication
(10) Pub. No.: US 2009/0305015 A1
(43) Pub. Date: Dec. 10, 2009

(54) CHILL CAST MULCH FILM

(75) Inventors: Jodi Fleck-Arnold, St. Mary's, PA (US); Mark Jordan, Chesterbrook, PA (US); Emit Stover, Newport News, VA (US)

Correspondence Address: MCANDREWS HELD & MALLOY, LTD, 500 WEST MADISON STREET, SUITE 3400, CHICAGO, IL, 60661, US

(73) Assignee: PLIANT CORPORATION, Schaumburg, IL (US)

(21) Appl. No.: 11/573,472

(22) PCT Filed: Sep. 1, 2004
(86) PCT No.: PCT/US2004/029301

§ 371 Date: Jun. 24, 2009

(51) Int. Cl. B32B 27/32; B32B 27/06; B29C 55/00

(52) U.S. Cl. 428/220; 428/336; 428/335; 428/334; 264/291

(57) ABSTRACT

The agricultural film of the present invention includes a monolayer and multilayer embodiment wherein a first layer is composed of at least one polyolefin polymer wherein the film has a thickness of from about 0.1-10 mils and the film is formed by chill cast extrusion. A method for making the agricultural film of the present invention is also provided.

### TECHNICAL FIELD

The present invention relates to agricultural polyolefin films suitable for covering soil for use in cropping or covering a frame in order to achieve a greenhouse effect. In particular, the present invention is directed to a polyolefin-based agricultural film manufactured using a chill cast configuration.

### BACKGROUND ART

In agriculture, wide use is made of crop protection or mulching films. Such films desirably cover, enclose or protect the soil and/or the growing crops under fully exposed outdoor conditions for a given period of time or time of year. Conventional mulch films are typically manufactured using standard cast embossed, blown smooth, or blown embossed technology. Thus, when certain agricultural operations take place, such as plowing or gathering of the crop, conventional mulch films constitute an obstacle to such operations and must be removed. Except for some cases in which the film can be re-used and is worth recovering, removal is a time consuming and costly operation due, in part, to the thickness and weight of the film. Thus, a desirable mulch film would have a smaller gauge while maintaining other necessary physical properties such as good tear, puncture, impact, and modulus.

### DISCLOSURE OF THE INVENTION

The agricultural film of the present invention includes a monolayer and multilayer embodiment wherein a first layer is composed of at least one polyolefin polymer wherein the film has a thickness of from about 0.1-10 mils and the film is formed by chill cast extrusion. A method for making the agricultural film of the present invention is also provided. In this method, a film resin is provided that is composed of at least one polyolefin polymer. The method also includes forming a film in a viscous amorphous state through a slot die onto a continuously moving chill roll. Next, the film is melt stretched and then cooled on the chill roll. Finally, the film is stretched to desired thickness of from about 0.1-10 mils to form the agricultural film of the present invention.

### BEST MODE FOR CARRYING OUT OF THE INVENTION

The agricultural film of the present invention has a structure that includes at least one first layer composed of at least one polyolefin polymer and, preferably, an additive package. Additional layers may also be provided that include at least one polyolefin polymer.

The total thickness or gauge of the film may vary and depends on the intended application for the film. The preferred monolayer film has a total thickness of from about 0.1-10 mils, more preferably from about 0.1-5 mils, and most preferably from about 0.1-3 mils. In a preferred multilayer embodiment, the preferred thickness of a first layer is preferably from about 0.1-10 mils. The preferred thickness of a second layer is preferably from about 0.1-0.45 mils. Each additional separate layer is preferably from about 0.1-9.9 mils. The preferred thickness of the first layer constitutes from about 1-100% by weight of the whole film structure, more preferably from about 50-95%, and most preferably from about 60-90%. It will be appreciated by those skilled in the art that the thickness of each individual layer may be similar or different in addition to having similar or different compositions. The thickness of each layer is therefore independent and may vary within the parameters set by the total thickness of the film.

In the preferred film, the preferred at least one first layer and at least one second layer is composed of from about 1-100% by weight, more preferably from about 70-90%, and most preferably from about 75-85%, of at least one polyolefin polymer. Preferred polyolefin polymers include polyethylene, polypropylene, polybutenes, polyisoprene, polyesters, homopolymers thereof, copolymers thereof, terpolymers thereof, α-olefin propylene copolymers, and mixtures thereof. Suitable polyethylenes include, in particular, low density polyethylene (LDPE) and linear low density polyethylene (LLDPE). Preferred propylene polymers generally contain from about 90-100% by weight of propylene units and the preferred propylene polymers generally have a melting point of 130° C. or above. Preferred propylene polymers generally have a melt flow index of from about 0.1-100 MFR. Isotactic propylene homopolymer having an n-heptane-soluble content of from about 1-15% by weight, copolymers of ethylene and propylene having an ethylene content of 10% by weight or less, copolymers of propylene with C₄-C₈ α-olefins having an α-olefin content of 10% by weight or less, and terpolymers of propylene, ethylene and butylene having an ethylene content of 10% by weight or less and a butylene content of 15% by weight or less are preferred propylene polymers. Also suitable is a mixture of propylene homopolymers, copolymers, terpolymers and other polyolefins. Particularly preferred are polypropylene homopolymers having a melt flow index of about 4 g/10 min at 230° C. and a density of 0.916 g/cm³ and also random copolymers having a density of 0.90 g/cm³ and a melt flow index of 2.1 g/10 min at 230° C. such as those manufactured by Exxon Mobile Chemical Company (Houston, Tex.).

The preferred polyolefin polymers also include metallocene-catalyzed polyolefin polymers. Preferred metallocenes are single site catalysts and include dicyclopentadienyl-metals and -metal halides. A preferred polyolefin polymer is an ethylene-based polymer such as a hexene, octene, butene, and superhexene copolymers produced with metallocene single site catalysts. Most preferred is metallocene linear low density polyethylene (mLLDPE) and metallocene low density polyethylene (mLDPE). The preferred mLLDPE and mLDPE have a melt index of about 1.0-5.0 g/10 min and a density of about 0.99 g/cm³ or less.

It will be appreciated by those skilled in the art that additives may be added to the first layer, second layer or to one or more other layers of the film of the present invention in order to improve certain characteristics of the particular layer or to meet special requirements of specific applications. From about 0-99% by weight of the preferred first layer, second layer or other individual layer, more preferably from about 10-30%, and most preferably from about 15-25%, of one or more additives may be added. Preferred additives include color concentrates, neutralizers, process aids, lubricants, stabilizers, hydrocarbon resins, antistatics, slip agents, antiblocking agents, antioxidants, fillers, and specialty additives for specific applications.

A color concentrate may be added to the layer to yield a colored layer, an opaque layer, or a translucent layer. Preferred color concentrates include color formulations including black, especially carbon black, white, and other colors suitable for agricultural films such as those manufactured by Ampacet Corporation (Tarrytown, N.Y.). Preferred color concentrates include Ampacet® white UV PE masterbatch, the carrier resin of which being a LDPE having a melt index of 12 g/10 min at 190° C. and a density of 0.916 gm/cc and the concentrate of which has a nominal specific gravity of 1.79, a melt index of 2-8 g/10 min at 190° C. and a pigment composed of 65% TiO₂. Another preferred color concentrate includes Ampacet® black PE masterbatch, the carrier resin of which being a LLDPE having a nominal melt index of 20 g/10 min at 190° C. and a density of 0.92 gm/cc. The concentrate has a nominal specific gravity of 1.15, a melt index of <6 g/10 min at 190° C., and a pigment composed of 40% carbon black. Another preferred color concentrate includes Ampacet® black UV PE masterbatch, the carrier resin of which being a LDPE or LLDPE having a nominal melt index of 24 g/10 min at 190° C. and a density of 0.92 gm/cc. The concentrate has a specific gravity of 1.14, a melt index of 4-10 gm/cc at 190° C., and contains about 40% carbon black. It will be appreciated by those skilled in the art that any suitable color concentrate may be used in order to satisfy particular requirements for a film being produced in accordance with the present invention.

Suitable neutralizers include calcium carbonate and calcium stearate. Preferred neutralizers have an absolute particle size of less than 10 μm and a specific surface area of at least 40 m²/g. Polymeric processing aids may also be used in a layer. Fluoropolymers, fluoropolymer blends, and fluoroelastomers are particularly preferred, but any processing aid known in the art for use in polymer films would be suitable. A particularly preferred processing aid is Ampacet® Process Aid masterbatch having a LLDPE carrier resin with a nominal melt index of 2 g/10 min at 190° C. and a density of 0.92 gm/cc. The concentrate therein has a nominal specific gravity of 0.93, a nominal melt index of 1-4 g/10 min, and contains 3% process aid.

Lubricants that may used in accordance with the present invention include higher aliphatic acid esters, higher aliphatic acid amides, metal soaps, polydimethylsiloxanes, and waxes. Conventional stabilizing compounds for polymers of ethylene, propylene, and other α-olefins are preferably employed in the present invention. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity and optical properties. In particular, adhesive resins are preferred. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments. Adhesive resins may be desirable in a laminated embodiment of the present invention.

Preferred antistatics include substantially straight-chain and saturated aliphatic, tertiary amines containing an aliphatic radical having 10-20 carbon atoms that are substituted by ω-hydroxy-(C₁-C₄)-alkyl groups, and N,N-bis-(2-hydroxyethyl)alkylamines having 10-20 carbon atoms in the allyl radical. Other suitable antistatics include ethyoxylated or propoxylated polydiorganosiloxanes such as polydialkysiloxanes and polyalkylphenylsiloxanes, and alkali metal alkanesulfonates.

Preferred slip agents include stearamide, oleamide, and erucamide. A particularly preferred slip agent is Ampacet® Slip PE masterbatch having a LDPE carrier resin with an 8 g/10 min melt index at 190 and a density of 0.918 gm/cc. The slip agent's concentrate has a nominal specific gravity of 0.92, a nominal melt index of 10-16 g/10 min and contains 5% erucamide. Slip agents may be used alone or in combination with antiblocking agents. A preferred slip/antiblock combination is Ampacet® Slip AB PE masterbatch having a LDPE carrier resin with an 8 g/10 min melt index at 190° C. and a density of 0.92 gm/cc. The slip agent's concentrate has a nominal specific gravity of 0.93, a nominal melt index of 5-14 g/10 min at 190° C. and contains 2% slip agent and 2% antiblock.

An antiblocking agent alone may also be added to a layer. Preferred antiblocking agents include organic polymers such as polyamides, polycarbonates, polyesters. Other preferred agents include calcium carbonate, aluminum silicate, magnesium silicate, calcium phosphate, silicon dioxide, and diatomaceous earth.

Antioxidants may also be added to a layer. Preferred antioxidants include aromatic amines such as di-β-naphthyl-p-phenylenediamine and phenyl-β-naphthylamine. Substituted phenolic compounds such as butylated hydroxyanisole, di-tert-butyl-p-creso, and propyl gallate may also be used.

In the preferred embodiments of the agricultural film of the present invention described hereinabove, the film structure is a monolayer or multilayer structure. It will be appreciated by those skilled in the art that additional layers could be added to the film to form a film having up to ten layers.

The agricultural film of the present invention may be produced by chill cast manufacturing methods known in the art. In the most preferred method, the film is formed as a plastics web in a viscous amorphous state through a slot die onto a continuously-moving water-cooled or oil cooled chill roll. The inlet temperature of the water is maintained at from about 8-12° C. to effectively cool the plastic. It is also preferred to have uniform surface temperature over the entire surface so that dew formation does not occur. The roll stack may be vertical, horizontal or included. Film thickness is regulated by the gap between the die lips as well as the rotational speed of the chill roll which is arranged to draw down and reduce thickness of the melt web. The die gap, therefore, may be set higher than the desired film thickness. Die-gap settings vary with each type of polymer used, the equipment being used, and the processing parameters. It is also important to precisely control the film thickness over the entire width, except the edges, which are thicker and are continuously trimmed off, ground and fed back to the hopper, by adjusting the points provided across the die width. On some available equipment, thickness indicators such as beta gauges are provided to continuously monitor variations across the width thereby enabling the operator to make precise adjustments. Some equipment also allows for automatic adjustment of the die lips to monitor and control the film thickness. Film roll quality can suffer if the traverse tolerance exceeds ±5% of the set thickness. This will result in uneven winding, creases, non-uniform treatment level and higher wastage in slitting and further processing.

The barrel temperatures are typically set between 180° C./240° C. and 300° C. to get better optical properties. A die temperature may be slightly higher to allow for the cooling due to exposure to lower ambient temperature. A constant temperature of the die across the entire width is very important so that the film draw-down rates and physical properties remain constant across the entire web. Any alteration of the set temperature profile across the die for controlling the film thickness will disturb these factors and adversely affect the film quality. The die is kept as close to the chill roll as possible, for example, between 40 and 80 mm, so that the web, which has low melt strength, remains unsupported for the minimum possible distance and time. The web flows on to the chill roll with a temperature of about 240° C. or more. If necessary, the web may be passed to a second chill roll for additional cooling and/or orientation of the film. The film then proceeds to edge trimming, tensioning and winding.

The first chill roll considerably influences the process quality. The cooling capacity must be adequate to chill the film even at high output rates and the temperature gradient across the width of the roll should not exceed ±1° C. The actual roll temperature depends on the desired film thickness, line speed and roll diameter, the typical set temperature being around 20° C. The chill roll drive speeds must also be controlled in order to control film draw-down and the final thickness of the film. The film is then melt stretched for a short distance in air, and cooled on the chill roll. The film is then stretched under controlled conditions. Suitable chill cast techniques are well known in the art and any known chill cast techniques may be used in the present invention.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

A black monolayer chill cast film having a total film thickness of 0.8 mils was produced using the formula set forth in Table 1

TABLE 1
Formulation 1 - Monolayer Film Formulation

| Wt % | Type | Mfr |
|---|---|---|
| 67.4 | LLDPE | Dow |
| 16.1 | LDPE | Dow |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 2

A black monolayer chill cast film having a total film thickness of 0.75 mils was produced using Formulation 1.

### Example 3

A black monolayer chill cast film having a total film thickness of 0.88 mils was produced using the formula set forth in Table 2

TABLE 2
Formulation 2 - Monolayer Film Formulation

| Wt % | Type | Mfr |
|---|---|---|
| 67.4 | LLDPE | Dow |
| 16.1 | PP Homopolymer | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 4

A black monolayer chill cast film having a total film thickness of 0.75 mils was produced using Formulation 2.

### Example 5

A black monolayer chill cast film having a total film thickness of 0.88 mils was produced using the formula set forth in Table 3.

TABLE 3
Formulation 3 - Monolayer Film Formulation

| Wt % | Type | Mfr |
|---|---|---|
| 51.3 | LLDPE | Dow |
| 32.2 | PP Homopolymer | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 6

A black monolayer chill cast film having a total film thickness of 0.75 mils was produced using Formulation 3.

### Example 7

A black monolayer chill cast film having a total film thickness of 0.88 mils was produced using the formula set forth in Table 4.

TABLE 4
Formulation 4 - Monolayer Film Formulation

| Wt % | Type | Mfr |
|---|---|---|
| 67.4 | LLDPE | Dow |
| 16.1 | Random COP | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 8

A black monolayer chill cast film having a total film thickness of 0.75 mils was produced using Formulation 4.

### Example 9

A black monolayer chill cast film having a total film thickness of 0.88 mils was produced using the formula set forth in Table 5.

TABLE 5
Formulation 5- Monolayer Film Formulation

| Wt % | Type | Mfr |
|---|---|---|
| 51.3 | LLDPE | Dow |
| 32.3 | Random COP | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 10

A black monolayer chill cast film having a total film thickness of 0.75 mils was produced using Formulation 5.

### Example 11

A black monolayer chill cast film having a total film thickness of 0.88 mils was produced using the formula set forth in Table 6.

TABLE 6
Formulation 6 - Monolayer Film Formulation

| Wt % | Type | Mfr |
|---|---|---|
| 66.8 | LLDPE | Dow |
| 16.7 | LDPE | Dow |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 12

A black monolayer chill cast film having a total film thickness of 0.88 mils was produced using the formula set forth in Table 7.

TABLE 7
Formulation 7 - Monolayer Film Formulation

| Wt % | Type | Mfr |
|---|---|---|
| 66.8 | LLDPE | Dow |
| 16.7 | PP Homopolymer | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 13

A black monolayer chill cast film having a total film thickness of 0.75 mils was produced using Formulation 7.

### Example 14

A black monolayer chill cast film having a total film thickness of 0.60 mils was produced using Formulation 7.

### Example 15

A black monolayer chill cast film having a total film thickness of 0.5 mils was produced using Formulation 7.

### Example 16

A black monolayer chill cast film having a total film thickness of 0.88 mils was produced using the formula set forth in Table 8.

TABLE 8
Formulation 8 - Monolayer Film Formulation

| Wt % | Type | Mfr |
|---|---|---|
| 66.8 | LLDPE | Dow |
| 16.7 | Random COP | Exxon |
| 15.0 | Black colorant | Ampacet |
| | masterbatch | |
| 0.5 | Process Aid | Ampacet |
| 1.0 | Slip/Antiblock | Ampacet |
| | masterbatch | |

### Example 17

A black monolayer chill cast film having a total film thickness of 0.75 mils was produced using Formulation 8.

### Example 18

A white monolayer chill cast film having a total film thickness of 0.75 mils was produced using the formula set forth in Table 9.

TABLE 9
Formulation 9 - Monolayer Film Formulation

| Wt % | Type | Mfr |
|---|---|---|
| 60.0 | LLDPE | Dow |
| 15.0 | PP Homopolymer | Exxon |
| 22.0 | White colorant | Ampacet |
| | masterbatch | |
| 1.5 | UVI masterbatch | Ampacet |
| 1.0 | Slip/Antiblock | Ampacet |
| | masterbatch | |
| 0.5 | Process Aid | Ampacet |

### Example 19

A white monolayer chill cast film having a total film thickness of 0.60 mils was produced using Formulation 9.

### Example 20

A two-layer white/black chill cast film having a total film thickness of 0.88 mils was produced using the formula set forth in Table 10.

TABLE 10
Formulation 10 - 2 Layer Film Formulation

| Layer | Ratio | Wt % | Type | Mfr |
|---|---|---|---|---|
| A | 60% | 60.0 | LLDPE | Dow |
| | | 15.0 | PP Homopolymer | Exxon |
| | | 22.0 | White colorant | Ampacet |
| | | | masterbatch | |
| | | 1.5 | UVI masterbatch | Ampacet |
| | | 0.5 | Process Aid | Ampacet |
| | | 1.0 | Slip/Antiblock | Ampacet |
| | | | masterbatch | |
| B | 40% | 66.8 | LLDPE | Dow |
| | | 16.7 | PP Homopolymer | Exxon |
| | | 15.0 | Black colorant | Ampacet |
| | | | masterbatch | |
| | | 0.5 | Process Aid | Ampacet |
| | | 1.0 | Slip/Antiblock | Ampacet |
| | | | masterbatch | |

### Example 21

A two-layer white/black chill cast film having a total thickness of 0.75 mils was produced using Formulation 10.

### Example 22

A two-layer white/black chill cast film having a total film thickness of 0.60 mils was produced using the formula set forth in Table 11.

TABLE 11
Formulation 11 - 2 Layer Film Formulation

| Layer | Ratio | Wt % | Type | Mfr |
|---|---|---|---|---|
| A | 60% | 60.0 | LLDPE | Dow |
| | | 15.0 | PP Homopolymer | Exxon |
| | | 22.0 | White colorant | Ampacet |
| | | | masterbatch | |
| | | 1.5 | UVI masterbatch | Ampacet |
| | | 0.5 | Process Aid | Ampacet |
| | | 1.0 | Slip/Antiblock | Ampacet |
| | | | masterbatch | |
| B | 40% | 66.8 | LLDPE | Dow |
| | | 16.7 | PP Homopolymer | Exxon |
| | | 15.0 | Black colorant | Ampacet |
| | | | masterbatch | |
| | | 0.5 | Process Aid | Ampacet |
| | | 1.0 | Slip/Antiblock | Ampacet |
| | | | masterbatch | |

### Example 23

A two-layer white/black chill cast film having a total film thickness of 0.60 mils was produced using the formula set forth in Table 12.

TABLE 12
Formulation 12 - 2 Layer Film Formulation

| Layer | Ratio | Wt % | Type | Mfr |
|---|---|---|---|---|
| A | 70% | 60.0 | LLDPE | Dow |
| | | 15.0 | PP Homopolymer | Exxon |
| | | 22.0 | White colorant | Ampacet |
| | | | masterbatch | |
| | | 1.5 | UVI masterbatch | Ampacet |
| | | 0.5 | Process Aid | Ampacet |
| | | 1.0 | Slip/Antiblock | Ampacet |
| | | | masterbatch | |
| B | 30% | 66.8 | LLDPE | Dow |
| | | 16.7 | PP Homopolymer | Exxon |
| | | 15.0 | Black colorant | Ampacet |
| | | | masterbatch | |
| | | 0.5 | Process Aid | Ampacet |
| | | 1.0 | Slip/Antiblock | Ampacet |
| | | | masterbatch | |

### Example 24

The physical properties of Formulation 1 as produced in Examples 1 and 2 above were determined. The results are shown below in Table 13.

TABLE 13
Formulation 1 Physical Properties Test Results.

| | ASTM | | Formu- | |
|---|---|---|---|---|
| | Test | | lation 1 | Formulation 1 |
| Property | # | Units | Example 1 | Example 2 |
| Gauge | D 2103 | mils | 0.85 | 0.77 |
| Light Transmission | D 1003 | % | 0.0 | 0.0 |
| Dart Drop | D 1709 | grams | 175 | 155 |
| Slow Puncture 1/32 | D 3763 | grams | 271 | 233 |
| Gloss (In) | D 2457 | % | 42.2 | 40.2 |
| Gloss (Out) | D 2457 | % | 40.8 | 39.3 |
| Reflectance (In) | D 2457 | % | 0.6 | 0.6 |
| Reflectance (Out) | D 2457 | % | 0.6 | 0.7 |
| M.D. Strip/Gauge | D 2103 | mils | 0.87 | 0.77 |
| M.D. Tensile @ Break | D 882 | psi | 4722 | 5941 |
| M.D. Elongation | D 882 | % | 563 | 631 |
| M.D. Yield | D 882 | psi | 1424 | 1460 |
| M.D. Elongation @ | D 882 | % | 14 | 14 |
| Yield | | | | |
| M.D. Tensile @ 5% | D 882 | psi | 971 | 931 |
| M.D. Tensile @ 10% | D 882 | psi | 1343 | 1358 |
| M.D. Tensile @ 25% | D 882 | psi | 1561 | 1600 |
| M.D. Trouser Tear | D 1938 | grams | 68 | 61 |
| M.D. Elmendorf Tear | D 1922 | grams | 266 | 258 |
| M.D. Secant Modulus | D 882 | psi | 26026 | 26187 |
| T.D. Strip/Gauge | D 2103 | mils | 0.87 | 0.79 |
| T.D. Tensile @ Break | D 882 | Psi | 4918 | 4973 |
| T.D. Elongation | D 882 | % | 712 | 724 |
| T.D. Yield | D 882 | psi | 1371 | 1383 |
| T.D. Elongation @ Yield | D 882 | % | 12 | 12 |
| T.D. Tensile @ 5% | D 882 | psi | 1030 | 1050 |
| T.D. Tensile @ 10% | D 882 | psi | 1347 | 1360 |
| T.D. Trouser Tear | D 1938 | grams | 91 | 81 |
| T.D. Elmendorf Tear | D 1922 | grams | 611 | 616 |
| T.D. Secant Modulus | D 882 | psi | 28743 | 28582 |
| C.O.F. (Inside/Inside) | D 1894 | — | 1.81 | 1.65 |
| C.O.F. (Outside/Outside) | D 1894 | — | 1.63 | 1.74 |

### Example 25

The physical properties of Formulation 2 as produced in Examples 3 and 4 above were determined. The results are shown below in Table 14.

TABLE 14
Formulation 2 Physical Properties Test Results.

| | ASTM | | Formu- | |
|---|---|---|---|---|
| | Test | | lation 1 | Formulation 1 |
| Property | # | Units | Example 1 | Example 2 |
| Gauge | D 2103 | mils | 0.94 | 0.77 |
| Light Transmission | D 1003 | % | 0.0 | 0.0 |
| Dart Drop | D 1709 | grams | 183 | 158 |
| Slow Puncture 1/32 | D 3763 | grams | 283 | 251 |
| Gloss (In) | D 2457 | % | 42.9 | 41.8 |
| Gloss (Out) | D 2457 | % | 41.1 | 42.2 |
| Reflectance (In) | D 2457 | % | 0.6 | 0.6 |
| Reflectance (Out) | D 2457 | % | 0.6 | 0.6 |
| M.D. Strip/Gauge | D 2103 | mils | 0.95 | 0.76 |
| M.D. Tensile @ Break | D 882 | psi | 6675 | 7157 |
| M.D. Elongation | D 882 | % | 634 | 633 |
| M.D. Yield | D 882 | psi | 1939 | 1932 |
| M.D. Elongation @ | D 882 | % | 12 | 12 |
| Yield | | | | |
| M.D. Tensile @ 5% | D 882 | psi | 1474 | 1456 |
| M.D. Tensile @ 10% | D 882 | psi | 1886 | 1870 |
| M.D. Tensile @ 25% | D 882 | psi | 1967 | 1977 |
| M.D. Trouser Tear | D 1938 | grams | 73 | 82 |
| M.D. Elmendorf Tear | D 1922 | grams | 403 | 344 |
| M.D. Secant Modulus | D 882 | psi | 48077 | 46808 |
| T.D. Strip/Gauge | D 2103 | mils | 0.95 | 0.74 |
| T.D. Tensile @ Break | D 882 | Psi | 4881 | 5287 |
| T.D. Elongation | D 882 | % | 672 | 672 |
| T.D. Yield | D 882 | psi | 1647 | 1767 |
| T.D. Elongation @ Yield | D 882 | % | 12 | 12 |
| T.D. Tensile @ 5% | D 882 | psi | 1315 | 1415 |
| T.D. Tensile @ 10% | D 882 | psi | 1613 | 1733 |
| T.D. Trouser Tear | D 1938 | grams | 92 | 62 |
| T.D. Elmendorf Tear | D 1922 | grams | 347 | 336 |
| T.D. Secant Modulus | D 882 | psi | 37693 | 38771 |
| C.O.F. (Inside/Inside) | D 1894 | — | 0.85 | 1.09 |
| C.O.F. (Outside/Outside) | D 1894 | — | 0.87 | 0.88 |

### Example 26

The physical properties of two samples of Formulation 3 as produced in Example 6 above were determined. The results are shown below in Table 15.

TABLE 15
Formulation 3 Physical Properties Test Results.

| | ASTM | | Formu- | |
|---|---|---|---|---|
| | Test | | lation 3 | Formulation 3 |
| Property | # | Units | Example 6 | Example 6 |
| Gauge | D 2103 | mils | 0.77 | 0.77 |
| Light Transmission | D 1003 | % | 0.0 | <1 |
| Dart Drop | D 1709 | grams | 104 | 128 |
| Slow Puncture 1/32 | D 3763 | grams | 225 | 231 |
| Gloss (In) | D 2457 | % | 38.3 | 33.5 |
| Gloss (Out) | D 2457 | % | 39.2 | 34.7 |
| Reflectance (In) | D 2457 | % | 0.7 | 0.9 |
| Reflectance (Out) | D 2457 | % | 0.8 | 0.9 |
| M.D. Strip/Gauge | D 2103 | mils | 0.77 | 0.73 |
| M.D. Tensile @ Break | D 882 | psi | 7812 | 8456 |
| M.D. Elongation | D 882 | % | 608 | 569 |
| M.D. Yield | D 882 | psi | 2637 | 2483 |
| M.D. Elongation @ | D 882 | % | 12 | 11 |
| Yield | | | | |
| M.D. Tensile @ 5% | D 882 | psi | 2122 | 1902 |
| M.D. Tensile @ 10% | D 882 | psi | 2579 | 2435 |
| M.D. Tensile @ 25% | D 882 | psi | 2603 | 2543 |
| M.D. Trouser Tear | D 1938 | grams | 73 | 52 |
| M.D. Elmendorf Tear | D 1922 | grams | 77 | 84 |
| M.D. Secant Modulus | D 882 | psi | 69765 | 66596 |
| T.D. Strip/Gauge | D 2103 | mils | 0.74 | 0.7 |
| T.D. Tensile @ Break | D 882 | Psi | 5267 | 5582 |
| T.D. Elongation | D 882 | % | 682 | 704 |
| T.D. Yield | D 882 | psi | 2349 | 2329 |
| T.D. Elongation @ Yield | D 882 | % | 12 | 12 |
| T.D. Tensile @ 5% | D 882 | psi | 1976 | 1940 |
| T.D. Tensile @ 10% | D 882 | psi | 2322 | 2307 |
| T.D. Tensile @ 25% | D 882 | psi | 2225 | 2196 |
| T.D. Trouser Tear | D 1938 | grams | 126 | 105 |
| T.D. Elmendorf Tear | D 1922 | grams | 221 | 366 |
| T.D. Secant Modulus | D 882 | psi | 61595 | 59755 |
| C.O.F. (Inside/Inside) | D 1894 | — | 0.73 | 0.73 |
| C.O.F. (Outside/Outside) | D 1894 | — | 0.73 | 0.75 |

### Example 27

The physical properties of two samples of Formulation 4 as produced in Examples 7 and 8 above were determined. The results are shown below in Table 16.

TABLE 16
Formulation 4 Physical Properties Test Results.

| | ASTM | | Formu- | |
|---|---|---|---|---|
| | Test | | lation 4 | Formulation 4 |
| Property | # | Units | Example 7 | Example 8 |
| Gauge | D 2103 | mils | 0.91 | 0.78 |
| Light Transmission | D 1003 | % | <1 | <1 |
| Dart Drop | D 1709 | grams | 165 | 185 |
| Slow Puncture 1/32 | D 3763 | grams | 323 | 304 |
| Gloss (In) | D 2457 | % | 38.0 | 37.9 |
| Gloss (Out) | D 2457 | % | 39.3 | 33.8 |
| Reflectance (In) | D 2457 | % | 0.8 | 0.8 |
| Reflectance (Out) | D 2457 | % | 0.7 | 0.8 |
| M.D. Strip/Gauge | D 2103 | mils | 0.87 | 0.74 |
| M.D. Tensile @ Break | D 882 | psi | 8003 | 7912 |
| M.D. Elongation | D 882 | % | 598 | 525 |
| M.D. Yield | D 882 | psi | 1800 | 1688 |
| M.D. Elongation @ | D 882 | % | 14 | 14 |
| Yield | | | | |
| M.D. Tensile @ 5% | D 882 | psi | 1375 | 1451 |
| M.D. Tensile @ 10% | D 882 | psi | 1831 | 1844 |
| M.D. Tensile @ 25% | D 882 | psi | 1721 | 1967 |
| M.D. Trouser Tear | D 1938 | grams | 86 | 72 |
| M.D. Elmendorf Tear | D 1922 | grams | 518 | 448 |
| M.D. Secant Modulus | D 882 | psi | 35219 | 31222 |
| T.D. Strip/Gauge | D 2103 | mils | 0.91 | 0.74 |
| T.D. Tensile @ Break | D 882 | Psi | 5393 | 5579 |
| T.D. Elongation | D 882 | % | 723 | 715 |
| T.D. Yield | D 882 | psi | 1602 | 1530 |
| T.D. Elongation @ Yield | D 882 | % | 13 | 13 |
| T.D. Tensile @ 5% | D 882 | psi | 1222 | 1115 |
| T.D. Tensile @ 10% | D 882 | psi | 1564 | 1488 |
| T.D. Tensile @ 25% | D 882 | psi | 1622 | 1556 |
| T.D. Trouser Tear | D 1938 | grams | 125 | 89 |
| T.D. Elmendorf Tear | D 1922 | grams | 514 | 438 |
| T.D. Secant Modulus | D 882 | psi | 34347 | 30844 |
| C.O.F. (Inside/Inside) | D 1894 | — | 0.87 | 0.98 |
| C.O.F. (Outside/Outside) | D 1894 | — | 0.94 | 1.07 |

### Example 28

The physical properties of Formulation 5 as produced in Examples 9 and 10 above were determined. The results are shown below in Table 17.

TABLE 17
Formulation 5 Physical Properties Test Results.

| | ASTM | | Formu- | |
|---|---|---|---|---|
| | Test | | lation 5 | Formulation 5 |
| Property | # | Units | Example 9 | Example 10 |
| Gauge | D 2103 | mils | 0.86 | 0.76 |
| Light Transmission | D 1003 | % | <1 | <1 |
| Dart Drop | D 1709 | grams | 149 | 96 |
| Slow Puncture 1/32 | D 3763 | grams | 278 | 222 |
| Gloss (In) | D 2457 | % | 33.4 | 27.4 |
| Gloss (Out) | D 2457 | % | 35.5 | 31.1 |
| Reflectance (In) | D 2457 | % | 0.8 | 0.8 |
| Reflectance (Out) | D 2457 | % | 0.8 | 0.8 |
| M.D. Strip/Gauge | D 2103 | mils | 0.92 | 0.75 |
| M.D. Tensile @ Break | D 882 | psi | 7511 | 6951 |
| M.D. Elongation | D 882 | % | 626 | 558 |
| M.D. Yield | D 882 | psi | 1843 | 2027 |
| M.D. Elongation @ | D 882 | % | 13 | 12 |
| Yield | | | | |
| M.D. Tensile @ 5% | D 882 | psi | 1202 | 1524 |
| M.D. Tensile @ 10% | D 882 | psi | 1750 | 1978 |
| M.D. Tensile @ 25% | D 882 | psi | 1866 | 2030 |
| M.D. Trouser Tear | D 1938 | grams | 76 | 66 |
| M.D. Elmendorf Tear | D 1922 | grams | 262 | 129 |
| M.D. Secant Modulus | D 882 | psi | 36788 | 46424 |
| T.D. Strip/Gauge | D 2103 | mils | 0.93 | 0.73 |
| T.D. Tensile @ Break | D 882 | Psi | 4959 | 5435 |
| T.D. Elongation | D 882 | % | 693 | 717 |
| T.D. Yield | D 882 | psi | 1660 | 1897 |
| T.D. Elongation @ Yield | D 882 | % | 13 | 12 |
| T.D. Tensile @ 5% | D 882 | psi | 1278 | 1531 |
| T.D. Tensile @ 10% | D 882 | psi | 1627 | 1874 |
| T.D. Tensile @ 25% | D 882 | psi | 1617 | 1806 |
| T.D. Trouser Tear | D 1938 | grams | 123 | 94 |
| T.D. Elmendorf Tear | D 1922 | grams | 514 | 512 |
| T.D. Secant Modulus | D 882 | psi | 36130 | 50778 |
| C.O.F. (Inside/Inside) | D 1894 | — | 0.75 | 0.77 |
| C.O.F. (Outside/Outside) | D 1894 | — | 0.82 | 0.86 |

### Example 29

The physical properties of Formulation 7 as produced in Examples 12, 13 and 15 above were determined using a vacuum box. The results are shown below in Table 18.

TABLE 18
Formulation 7 Physical Properties Test Results.

| | | | Formulation 7 | Formulation 7 | Formulation 7 |
|---|---|---|---|---|---|
| Property | ASTM Test # | Units | Example 12 | Example 13 | Example 15 |
| Gauge | D 2103 | mils | 0.87 | 0.76 | 0.49 |
| Light Transmission | D 1003 | % | 0.1 | 0.0 | 0.3 |
| Emboss Depth | D 3763 | mils | 1.2 | 1.3 | 0.7 |
| Dart Drop | D 1709 | grams | 184 | 182 | 150 |
| Slow Puncture 1/32 | D 3763 | grams | 256 | 248 | 149 |
| Gloss (In) | D 2457 | % | 36.2 | 33.0 | 24.6 |
| Gloss (Out) | D 2457 | % | 35.5 | 33.6 | 30.7 |
| Reflectance (In) | D 2457 | % | 0.7 | 0.9 | 1.0 |
| Reflectance (Out) | D 2457 | % | 0.8 | 0.9 | 1.0 |
| M.D. Strip/Gauge | D 2103 | mils | 0.88 | 0.76 | 0.46 |
| M.D. Tensile @ Break | D 882 | psi | 6780 | 6893 | 8218 |
| M.D. Elongation | D 882 | % | 606 | 573 | 518 |
| M.D. Yield | D 882 | psi | 1671 | 1774 | 1997 |
| M.D. Elongation @ | D 882 | % | 12 | 12 | 12 |
| Yield | | | | | |
| M.D. Tensile @ 5% | D 882 | psi | 1238 | 1227 | 1209 |
| M.D. Tensile @ 10% | D 882 | psi | 1626 | 1716 | 1890 |
| M.D. Tensile @ 25% | D 882 | psi | 1732 | 1856 | 2156 |
| M.D. Trouser Tear | D 1938 | grams | 57 | 67 | 36 |
| M.D. Elmendorf Tear | D 1922 | grams | 255 | 199 | 65 |
| M.D. Secant Modulus | D 882 | psi | 36056 | 41552 | 44851 |
| T.D. Strip/Gauge | D 2103 | mils | 0.89 | 0.75 | 0.44 |
| T.D. Tensile @ Break | D 882 | psi | 5051 | 5561 | 4134 |
| T.D. Elongation | D 882 | % | 656 | 673 | 568 |
| T.D. Yield | D 882 | psi | 1616 | 1753 | 1778 |
| T.D. Elongation @ Yield | D 882 | % | 13 | 13 | 13 |
| T.D. Tensile @ 5% | D 882 | psi | 1209 | 1262 | 1337 |
| T.D. Tensile @ 10% | D 882 | psi | 1552 | 1677 | 1716 |
| T.D. Tensile @ 25% | D 882 | psi | 1672 | 1789 | 1784 |
| T.D. Trouser Tear | D 1938 | grams | 80 | 99 | 68 |
| T.D. Elmendorf Tear | D 1922 | grams | 285 | 273 | 202 |
| T.D. Secant Modulus | D 882 | psi | 32739 | 33823 | 37899 |
| C.O.F. (Inside/Inside) | D 1894 | — | 0.73 | 0.60 | 0.73 |
| C.O.F. (Outside/Outside) | D 1894 | — | 0.71 | 0.69 | 0.73 |

### Example 30

The physical properties of Formulation 7 as produced in Examples 12, 13 and 15 above were determined without using a vacuum box. The results are shown below in Table 19.

TABLE 19
Formulation 7 Physical Properties Test Results.

| | | | Formulation 7 | Formulation 7 | Formulation 7 |
|---|---|---|---|---|---|
| Property | ASTM Test # | Units | Example 12 | Example 13 | Example 15 |
| Gauge | D 2103 | mils | 0.89 | 0.76 | 0.58 |
| Light Transmission | D 1003 | % | 0.2 | 0.1 | 0.4 |
| Emboss Depth | D 3763 | mils | 1.2 | 1.1 | 0.8 |
| Dart Drop | D 1709 | grams | 160 | 183 | 165 |
| Slow Puncture 1/32 | D 3763 | grams | 283 | 250 | 208 |
| Gloss (In) | D 2457 | % | 39.6 | 36.7 | 32.6 |
| Gloss (Out) | D 2457 | % | 37.5 | 36.9 | 31.9 |
| Reflectance (In) | D 2457 | % | 0.6 | 0.6 | 0.6 |
| Reflectance (Out) | D 2457 | % | 0.6 | 0.6 | 0.7 |
| M.D. Strip/Gauge | D 2103 | mils | 0.90 | 0.77 | 0.58 |
| M.D. Tensile @ Break | D 882 | psi | 6675 | 6548 | 6565 |
| M.D. Elongation | D 882 | % | 663 | 642 | 612 |
| M.D. Yield | D 882 | psi | 1952 | 1911 | 2128 |
| M.D. Elongation @ | D 882 | % | 12 | 13 | 12 |
| Yield | | | | | |
| M.D. Tensile @ 5% | D 882 | psi | 1547 | 1443 | 1687 |
| M.D. Tensile @ 10% | D 882 | psi | 1921 | 1860 | 2093 |
| M.D. Tensile @ 25% | D 882 | psi | 1934 | 1902 | 2118 |
| M.D. Trouser Tear | D 1938 | grams | 69 | 66 | 48 |
| M.D. Elmendorf Tear | D 1922 | grams | 398 | 289 | 234 |
| M.D. Secant Modulus | D 882 | psi | 52307 | 48421 | 54080 |
| T.D. Strip/Gauge | D 2103 | mils | 0.89 | 0.77 | 0.57 |
| T.D. Tensile @ Break | D 882 | Psi | 5164 | 5039 | 4746 |
| T.D. Elongation | D 882 | % | 688 | 686 | 678 |
| T.D. Yield | D 882 | psi | 1719 | 1631 | 1588 |
| T.D. Elongation @ Yield | D 882 | % | 12 | 13 | 12 |
| T.D. Tensile @ 5% | D 882 | psi | 1383 | 1223 | 1262 |
| T.D. Tensile @ 10% | D 882 | psi | 1689 | 1586 | 1559 |
| T.D. Tensile @ 25% | D 882 | psi | 1753 | 1662 | 1567 |
| T.D. Trouser Tear | D 1938 | grams | 88 | 96 | 66 |
| T.D. Elmendorf Tear | D 1922 | grams | 343 | 364 | 199 |
| T.D. Secant Modulus | D 882 | psi | 40868 | 32404 | 37622 |
| C.O.F. (Inside/Inside) | D 1894 | — | 0.72 | 0.67 | 0.72 |
| C.O.F. (Outside/Outside) | D 1894 | — | 0.69 | 0.70 | 0.75 |

### Example 31

The physical properties of Formulation 7 as produced in Example 12 and the physical properties of Formulation 8 as produced in Example 16 were determined and compared. The results are shown below in Table 20.

TABLE 20
Formulations 7 and 8 Physical Properties Test Results.

| | ASTM | | Formu- | Formu- |
|---|---|---|---|---|
| | Test | | lation 7 | lation 8 |
| Property | # | Units | Example 12 | Example 16 |
| Gauge | D 2103 | mils | 0.75 | 0.80 |
| Light Transmission | D 1003 | % | 0.02 | 0.00 |
| Emboss Depth | D 3763 | mils | 1.0 | 1.4 |
| Dart Drop | D 1709 | grams | 167 | 151 |
| Slow Puncture 1/32 | D 3763 | grams | 224 | 226 |
| Gloss (In) | D 2457 | % | 30.3 | 36.7 |
| Gloss (Out) | D 2457 | % | 35.6 | 36.3 |
| Reflectance (In) | D 2457 | % | 0.6 | 0.6 |
| Reflectance (Out) | D 2457 | % | 0.6 | 0.5 |
| M.D. Strip/Gauge | D 2103 | mils | 0.76 | 0.83 |
| M.D. Tensile @ Break | D 882 | psi | 6170 | 6008 |
| M.D. Elongation | D 882 | % | 636 | 669 |
| M.D. Yield | D 882 | psi | 1992 | 1764 |
| M.D. Elongation @ | D 882 | % | 12 | 12 |
| Yield | | | | |
| M.D. Tensile @ 5% | D 882 | psi | 1609 | 1375 |
| M.D. Tensile @ 10% | D 882 | psi | 1966 | 1733 |
| M.D. Tensile @ 25% | D 882 | psi | 1962 | 1735 |
| M.D. Trouser Tear | D 1938 | grams | 60 | 61 |
| M.D. Elmendorf Tear | D 1922 | grams | 502 | 621 |
| M.D. Secant Modulus | D 882 | psi | 50918 | 42579 |
| T.D. Strip/Gauge | D 2103 | mils | 0.76 | 0.84 |
| T.D. Tensile @ Break | D 882 | Psi | 5152 | 4589 |
| T.D. Elongation | D 882 | % | 641 | 640 |
| T.D. Yield | D 882 | psi | 1821 | 1552 |
| T.D. Elongation @ Yield | D 882 | % | 13 | 12 |
| T.D. Tensile @ 5% | D 882 | psi | 1434 | 1229 |
| T.D. Tensile @ 10% | D 882 | psi | 1776 | 1525 |
| T.D. Tensile @ 25% | D 882 | psi | 1849 | 1550 |
| T.D. Trouser Tear | D 1938 | grams | 71 | 86 |
| T.D. Elmendorf Tear | D 1922 | grams | 307 | 406 |
| T.D. Secant Modulus | D 882 | psi | 39201 | 35458 |
| C.O.F. (Inside/Inside) | D 1894 | — | 0.72 | 0.85 |
| C.O.F. (Outside/Outside) | D 1894 | — | 0.76 | 0.83 |

### Example 32

The physical properties of Formulation 9 as produced in Examples 18 and 19 were determined. The results are shown below in Table 21.

TABLE 21
Formulation 9 Physical Properties Test Results.

| | ASTM | | Formu- | Formu- |
|---|---|---|---|---|
| | Test | | lation 9 | lation 9 |
| Property | # | Units | Example 18 | Example 19 |
| Gauge | D 2103 | mils | 0.78 | 0.63 |
| Light Transmission | D 1003 | % | 42.1 | 45.8 |
| Emboss Depth | D 3763 | mils | 1.7 | 1.5 |
| Dart Drop | D 1709 | grams | 157 | 116 |
| Slow Puncture 1/32 | D 3763 | grams | 243 | 240 |
| Gloss (In) | D 2457 | % | 42.4 | 43.4 |
| Gloss (Out) | D 2457 | % | 43.4 | 43.3 |
| Reflectance (In) | D 2457 | % | 63.0 | 58.3 |
| Reflectance (Out) | D 2457 | % | 62.1 | 58.5 |
| M.D. Strip/Gauge | D 2103 | mils | 0.79 | 0.62 |
| M.D. Tensile @ Break | D 882 | psi | 5479 | 5463 |
| M.D. Elongation | D 882 | % | 606 | 589 |
| M.D. Yield | D 882 | psi | 1876 | 1928 |
| M.D. Elongation @ | D 882 | % | 12 | 12 |
| Yield | | | | |
| M.D. Tensile @ 5% | D 882 | psi | 1535 | 1564 |
| M.D. Tensile @ 10% | D 882 | psi | 1852 | 1899 |
| M.D. Tensile @ 25% | D 882 | psi | 1866 | 1948 |
| M.D. Trouser Tear | D 1938 | grams | 52 | 39 |
| M.D. Elmendorf Tear | D 1922 | grams | 244 | 148 |
| M.D. Secant Modulus | D 882 | psi | 53866 | 52445 |
| T.D. Strip/Gauge | D 2103 | mils | 0.75 | 0.61 |
| T.D. Tensile @ Break | D 882 | psi | 4868 | 4421 |
| T.D. Elongation | D 882 | % | 669 | 648 |
| T.D. Yield | D 882 | psi | 1658 | 1682 |
| T.D. Elongation @ Yield | D 882 | % | 12 | 13 |
| T.D. Tensile @ 5% | D 882 | psi | 1300 | 1347 |
| T.D. Tensile @ 10% | D 882 | psi | 1628 | 1651 |
| T.D. Tensile @ 25% | D 882 | psi | 1636 | 1653 |
| T.D. Trouser Tear | D 1938 | grams | 64 | 55 |
| T.D. Elmendorf Tear | D 1922 | grams | 304 | 260 |
| T.D. Secant Modulus | D 882 | psi | 38700 | 38694 |
| C.O.F. (Inside/Inside) | D 1894 | — | 0.79 | 0.78 |
| C.O.F. (Outside/Outside) | D 1894 | — | 0.80 | 0.76 |

### Example 33

The physical properties of Formulations 10, 11 and 12 as produced in Examples 20-23 were determined. The results are shown below in Table 22.

TABLE 22
Formulations 10, 11 and 12 Physical Properties Test Results.

| | | | Formulation | Formulation | Formulation | Formulation |
|---|---|---|---|---|---|---|
| | | | 10 | 10 | 11 | 12 |
| Property | ASTM Test # | Units | Example 20 | Example 21 | Example 22 | Example 23 |
| Gauge | D 2103 | Mils | 0.92 | 0.77 | 0.61 | 0.61 |
| Light Transmission | D 1003 | % | 0.61 | 0.61 | 2.51 | 3.61 |
| Emboss Depth | D 3763 | mils | 1.2 | 1.8 | 1.6 | 1.4 |
| Dart Drop | D 1709 | grams | 141 | 124 | 106 | 121 |
| Slow Puncture 1/32 | D 3763 | grams | 236 | 195 | 193 | 193 |
| Gloss (In) | D 2457 | % | 41.5 | 43.1 | 42.6 | 36.3 |
| Gloss (Out) | D 2457 | % | 36.1 | 34.6 | 31.5 | 24.1 |
| Reflectance (In) | D 2457 | % | 40.0 | 38.0 | 31.2 | 34.6 |
| Reflectance (Out) | D 2457 | % | 0.6 | 0.6 | 0.8 | 1.2 |
| M.D. Strip/Gauge | D 2103 | mils | 0.97 | 0.75 | 0.61 | 0.64 |
| M.D. Tensile @ Break | D 882 | psi | 5377 | 5551 | 5547 | 5755 |
| M.D. Elongation | D 882 | % | 625 | 596 | 591 | 564 |
| M.D. Yield | D 882 | psi | 1973 | 2064 | 2114 | 1884 |
| M.D. Elongation @ | D 882 | % | 12 | 12 | 13 | 11 |
| Yield | | | | | | |
| M.D. Tensile @ 5% | D 882 | psi | 1614 | 1677 | 1660 | 1425 |
| M.D. Tensile @ 10% | D 882 | psi | 1946 | 2030 | 2068 | 1851 |
| M.D. Tensile @ 25% | D 882 | psi | 1959 | 2079 | 2140 | 1959 |
| M.D. Trouser Tear | D 1938 | grams | 71 | 48 | 46 | 40 |
| M.D. Elmendorf Tear | D 1922 | grams | 292 | 215 | 151 | 133 |
| M.D. Secant Modulus | D 882 | psi | 56623 | 51261 | 46383 | 41184 |
| T.D. Strip/Gauge | D 2103 | mils | 0.99 | 0.76 | 0.63 | 0.60 |
| T.D. Tensile @ Break | D 882 | Psi | 3942 | 4235 | 3924 | 4477 |
| T.D. Elongation | D 882 | % | 647 | 652 | 638 | 643 |
| T.D. Yield | D 882 | psi | 1666 | 1791 | 1752 | 1683 |
| T.D. Elongation @ Yield | D 882 | % | 12 | 12 | 11 | 12 |
| T.D. Tensile @ 5% | D 882 | psi | 1401 | 1508 | 1531 | 1364 |
| T.D. Tensile @ 10% | D 882 | psi | 1653 | 1781 | 1750 | 1660 |
| T.D. Tensile @ 25% | D 882 | psi | 1542 | 1650 | 1577 | 1639 |
| T.D. Trouser Tear | D 1938 | grams | 109 | 76 | 72 | 57 |
| T.D. Elmendorf Tear | D 1922 | grams | 389 | 300 | 252 | 249 |
| T.D. Secant Modulus | D 882 | psi | 43531 | 46475 | 45304 | 37543 |
| C.O.F. (Inside/Inside) | D 1894 | — | 0.64 | 0.65 | 0.62 | 0.73 |
| C.O.F. (Outside/Outside) | D 1894 | — | 0.61 | 0.63 | 0.65 | 0.73 |

### Example 34

A three-layer white/black chill cast film having a total film thickness of 0.88 mils was produced using the formula set forth in Table 23.

TABLE 23
Formulation 13 - 3 Layer Film Formulation

| Layer | Ratio | Wt % | Type | Mfr |
|---|---|---|---|---|
| A | 45% | 56.8 | LLDPE | Dow |
| | | 14.2 | PP Homopolymer | Exxon |
| | | 22.0 | White UV colorant | Standridge |
| | | | masterbatch | |
| | | 1.5 | UVI/AO masterbatch | Ampacet |
| | | 0.5 | Process Aid | Ampacet |
| | | 0.5 | Slip/Antiblock | Ampacet |
| | | | masterbatch | |
| | | 3.0 | Anitiblock | Ampacet |
| B | 40% | 56.8 | LLDPE | Dow |
| | | 14.2 | PP Homopolymer | Exxon |
| | | 22.0 | White UV colorant | Standridge |
| | | | masterbatch | |
| | | 0.5 | Process Aid | Ampacet |
| | | 2.0 | Slip/Antiblock | Ampacet |
| | | | masterbatch | |
| | | 1.5 | UVI/AO masterbatch | Ampacet |
| | | 3.0 | Antiblock | Ampacet |
| C | 15% | 55.6 | LLDPE | Dow |
| | | 13.9 | PP Homopolymer | Exxon |
| | | 25.0 | Black colorant | Ampacet |
| | | | masterbatch | |
| | | 0.5 | Process Aid | Ampacet |
| | | 2.0 | Slip/Antiblock | Ampacet |
| | | | masterbatch | |
| | | 3.0 | Antibtock | Ampacet |

### Example 35

The physical properties of Formulation 13 as produced in Example 34 was determined. The results are shown below in Table 24.

TABLE 24
Formulation 13 Physical Properties Test Results.

| | | | Formulation |
|---|---|---|---|
| | | | 13 |
| Property | ASTM Test # | Units | Example 34 |
| Gauge | D 2103 | mils | .91 |
| Light Transmission | D 1003 | % | 4.11 |
| Emboss Depth | D 3763 | mils | 1.6 |
| Dart Drop | D 1709 | grams | 170 |
| Slow Puncture 1/32 | D 3763 | grams | 418 |
| Gloss (White) | D 2457 | % | 42.4 |
| Gloss (Black) | D 2457 | % | 25.1 |
| Reflectance (White) | D 2457 | % | 55.1 |
| Reflectance (Black) | D 2457 | % | 1.6 |
| M.D. Strip/Gauge | D 2103 | mils | .91 |
| M.D. Tensile @ Break | D 882 | psi | 4608 |
| M.D. Elongation | D 882 | % | 521 |
| M.D. Yield | D 882 | psi | 1666 |
| M.D. Elongation @ | D 882 | % | 12 |
| Yield | | | |
| M.D. Tensile @ 5% | D 882 | psi | 1346 |
| M.D. Tensile @ 10% | D 882 | psi | 1635 |
| M.D. Tensile @ 25% | D 882 | psi | 1753 |
| M.D. Trouser Tear | D 1938 | grams | 41 |
| M.D. Elmendorf Tear | D 1922 | grams | 229 |
| M.D. Secant Modulus | D 882 | psi | 36482 |
| T.D. Strip/Gauge | D 2103 | mils | 0.91 |
| T.D. Tensile @ Break | D 882 | Psi | 3685 |
| T.D. Elongation | D 882 | % | 619 |
| T.D. Yield | D 882 | psi | 1493 |
| T.D. Elongation @ Yield | D 882 | % | 12 |
| T.D. Tensile @ 5% | D 882 | psi | 1231 |
| T.D. Tensile @ 10% | D 882 | psi | 1470 |
| T.D. Tensile @ 25% | D 882 | psi | 1507 |
| T.D. Trouser Tear | D 1938 | grams | 71 |
| T.D. Elmendorf Tear | D 1922 | grams | 372 |
| T.D. Secant Modulus | D 882 | psi | 33349 |
| C.O.F. (White/White) | D 1894 | — | 0.60 |
| Green | | | |
| C.O.F. (Black/Black) | D 1894 | — | 0.59 |
| Green | | | |
| C.O.F. (White/White) | D 1894 | — | 0.53 |
| 48 Hrs Aged | | | |
| C.O.F. (Black/Black) | D 1894 | — | 0.43 |
| 48 Hrs Aged | | | |

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. It is intended that the scope of the invention not be limited by the specification, but be defined by the claims set forth below.

We claim:

1. An monolayer agricultural film comprising:
at least one polyolefin polymer,
wherein said film has a thickness of from about 0.1-10 mils;
wherein said film is formed by chill cast extrusion.

2. The film of claim 1 wherein said film comprises from about 1-100% by weight of said at least one polyolefin polymer.

3. The film of claim 2 wherein said film comprises from about 70-90% by weight of said at least one polyolefin polymer.

4. The film of claim 1 wherein said polyolefin polymer is selected from the group consisting of polyethylene, polypropylene, polybutenes, polyisoprene, polyesters, homopolymers thereof, copolymers thereof, terpolymers thereof, α-olefin propylene copolymers, metallocene-catalyzed polyolefin polymers, and mixtures thereof.

5. The film of claim 4 wherein said polyolefin polymer is selected from the group consisting of linear low density polyethylene, low density polyethylene, and mixtures thereof.

6. The film of claim 4 wherein said polyolefin polymer is selected from the group consisting of linear low density polyethylene, low density polyethylene, propylene homopolymers, random copolymers, and mixtures thereof.

7. The film of claim 2, said film further comprising from about 0-99% by weight of at least one additive.

8. The film of claim 7, said film further comprising from about 10-30% by weight of at least one additive.

9. The film of claim 8 wherein said additive is selected from the group consisting of color concentrates, neutralizers, process aids, lubricants, stabilizers, hydrocarbon resins, antistatics, slip agents, antioxidants, fillers, specialty additives, and antiblocking agents.

10. The film of claim 1 wherein said film has a thickness of from about 0.1-5 mils.

11. A multilayer agricultural film comprising:
at least one first layer comprising at least one polyolefin polymer; and
at least one second layer comprising at least one polyolefin polymer;
wherein said film has a thickness of up from about 0.1-10 mils;
wherein said film is formed by chill cast extrusion.

12. The film of claim 11 wherein said first layer comprises from about 1-100% by weight of said at least one polyolefin polymer.

13. The film of claim 12 wherein said first layer comprises from about 70-90% by weight of said at least one polyolefin polymer.

14. The film of claim 13 wherein said polyolefin polymer is selected from the group consisting of polyethylene, polypropylene, polybutenes, polyisoprene, polyester, homopolymers thereof copolymers thereof, terpolymers thereof, α-olefin propylene copolymers, metallocene-catalyzed polyolefin polymers, and mixtures thereof.

15. The film of claim 14 wherein said polyolefin polymer is selected from the group consisting of linear low density polyethylene, low density polyethylene, and mixtures thereof.

16. The film of claim 14 wherein said polyolefin polymer is selected from the group consisting of linear low density polyethylene, low density polyethylene, propylene homopolymers, random copolymers, and mixtures thereof.

17. The film of claim 2, said first layer further comprising from about 0-99% by weight of at least one additive.

18. The film of claim 17, said first layer further comprising from about 10-30% by weight of at least one additive.

19. The film of claim 18 wherein said additive is selected from the group consisting of color concentrates, neutralizers, process aids, lubricants, stabilizers, hydrocarbon resins, antistatics, slip agents, antioxidants, fillers, specialty additives, and antiblocking agents.

20. The film of claim 11 wherein said second layer comprises from about 1-100% by weight of said at least one polyolefin polymer.

21. The film of claim 20 wherein said second layer comprises from about 70-90% by weight of said at least one polyolefin polymer.

22. The film of claim 21 wherein said polyolefin polymer is selected from the group consisting of polyethylene, polypropylene, polybutenes, polyisoprene, polyester, homopolymers thereof, copolymers thereof, terpolymers thereof, α-olefin propylene copolymers, metallocene-catalyzed polyolefin polymers, and mixtures thereof.

23. The film of claim 22 wherein said polyolefin polymer is selected from the group consisting of linear low density polyethylene, low density polyethylene, and mixtures thereof.

24. The film of claim 22 wherein said polyolefin polymer is selected from the group consisting of linear low density polyethylene, low density polyethylene, propylene homopolymers, random copolymers, and mixtures thereof.

25. The film of claim 20, said second layer further comprising from about 0-99% by weight of at least one additive.

26. The film of claim 25, said second layer further comprising from about 10-30% by weight of at least one additive.

27. The film of claim 26 wherein said additive is selected from the group consisting of color concentrates, neutralizers, process aids, lubricants, stabilizers, hydrocarbon resins, antistatics, slip agents, antioxidants, fillers, specialty additives, and antiblocking agents.

28. The film of claim 11 wherein said film has a thickness of from about 0.1-5 mils.

29. The film of claim 11 wherein said first layer comprises from about 1-100% by weight of said film.

30. The film of claim 29 wherein said first layer comprises from about 50-80% by weight of said film.

31. The film of claim 11 wherein said first layer has a thickness of from about 0.1-10 mils.

32. The film of claim 11 wherein said second layer has a thickness of from about 0.1-9.9 mils.

33. The film of claim 11 wherein said film further comprises at least one additional layer.

34. The film of claim 33, said at least one additional layer comprising at least one polyolefin polymer selected from the group consisting of polyethylene, polypropylene, polybutenes, polyisoprene, polyester, homopolymers thereof, copolymers thereof, terpolymers thereof, α-olefin propylene copolymers, metallocene-catalyzed polyolefin polymers, and mixtures thereof.

35. The film of claim 33, wherein said at least one additional layer has a thickness of from about 0.1-9.8 mils.

36. A method for making an agricultural film comprising the steps of:
providing a film resin composed of at least one polyolefin polymer,
feeding said resin through a slit die onto a continuously moving chill roll to form an agricultural film;
cooling said film on said chill roll;
stretching said film to a thickness of from about 0.1-10 mils.

37. The method of claim 36 wherein said film comprises from about 1-100% by weight of said at least one polyolefin polymer.

38. The method of claim 37 wherein said film comprises from about 70-90% by weight of said at least one polyolefin polymer.

39. The method of claim 36 wherein said polyolefin polymer is selected from the group consisting of polyethylene, polypropylene, polybutenes, polyisoprene, polyester, homopolymers thereof, copolymers thereof, terpolymers thereof, α-olefin propylene copolymers, metallocene-catalyzed polyolefin polymers, and mixtures thereof.

40. The method of claim 39 wherein said polyolefin polymer is selected from the group consisting of linear low density polyethylene, low density polyethylene, and mixtures thereof.

41. The method of claim 39 wherein said polyolefin polymer is selected from the group consisting of linear low density polyethylene, low density polyethylene, propylene homopolymers, random copolymers, and mixtures thereof.

42. The method of claim 37, said film further comprising from about 0-99% by weight of at least one additive.

43. The method of claim 42 wherein said additive is selected from the group consisting of color concentrates, neutralizers, process aids, lubricants, stabilizers, hydrocarbon resins, antistatics, slip agents, antioxidants, fillers, specialty additives, and antiblocking agents.

44. The method of claim 36 wherein said film has a thickness of from about 0.1-5 mils.

45. The method of claim 16, said film comprising one or more layers.

46. The method of claim 45, said layers comprising at least one polyolefin polymer selected from the group consisting of polyethylene, polypropylene, polybutenes, polyisoprene, polyester, homopolymers thereof, copolymers thereof, terpolymers thereof, α-olefin propylene copolymers, metallocene-catalyzed polyolefin polymers, and mixtures thereof.
